(19) United States
(12) Patent Application Publication
(10) Pub. No.: US 2022/0118724 A1
(43) Pub. Date: Apr. 21, 2022

(54) COOLING METHOD FOR AUTOCLAVE MOLDING APPARATUS

(71) Applicant: ASHIDA MFG CO., LTD., Ikoma-shi, Nara (JP)

(72) Inventors: Yoshiaki YAMAMOTO, Ikoma-shi, Nara (JP); Takeshi ASHIDA, Ikoma-shi, Nara (JP)

(21) Appl. No.: 17/430,139

(22) PCT Filed: Feb. 21, 2019
(86) PCT No.: PCT/JP2019/006635

§ 371 Date: Aug. 11, 2021

(51) Int. Cl. B29C 70/54; B29C 35/16; B29C 70/44

(52) U.S. Cl. CPC B29C 70/54; B29C 2035/1616; B29C 70/443; B29C 35/16

(57) ABSTRACT

A cooling method is for a steam heating type autoclave molding apparatus. The autoclave molding apparatus includes: a cylindrical vessel in which a vacuum bag containing a composite material composed of a fibrous base material and a matrix and a molding tool is to be placed; a steam supply unit configured to supply steam at a predetermined temperature into the cylindrical vessel; a steam release unit configured to release the steam used for molding the composite material from the cylindrical vessel; and a cooling water supply unit configured to supply cooling water for cooling the molded composite material. The cooling method includes: releasing the steam through the steam release unit to cool the molded composite material; and then spraying the cooling water supplied from the cooling water supply unit to cool the molded composite material.

### TECHNICAL FIELD

The present invention relates to a cooling method for an autoclave molding apparatus for use in forming composite material molded articles used in aircraft, automobile and other general industries.

### BACKGROUND ART

A molded article having a desired cross-sectional shape can be obtained by a known technique, in which sheets of prepreg, i.e., a composite material produced by impregnating a reinforcing material, such as carbon fiber, aramid fiber, or glass fiber, with a thermosetting resin matrix, such as epoxy resin or phenol resin, are heated and compression-molded. Carbon fiber and glass fiber have high elasticity. Therefore, these fibers are formed into thin fiber sheets, which are laminated such that the fibers in the adjacent sheets are oriented in different directions to obtain a composite material. Since lightweight and strong products can be obtained from such composite materials, these materials are widely used in aircraft, automobile and other general industries. A composite material having a thermosetting resin matrix has the property that it is soft at room temperature, but when it is heated to a predetermined temperature, it is cured at that temperature while generating heat of reaction.

An autoclave molding apparatus disclosed in Patent Literature 1 (Japanese Unexamined Patent Application Publication No. 2009-51074) below is used as an apparatus for molding these composite materials. As shown in FIG. 4, a composite material 101 is sealed together with a molding tool 102 in a heat and pressure resistant vacuum bag 103, which is then placed in a cylindrical vessel 105 through a door 104. The air in the cylindrical vessel 105 is heated by a heater 106 to raise the temperature of the composite material 101 to a predetermined temperature. The pressure increases as the temperature increases. If higher pressure is needed, a compressed gas is introduced from outside (not shown) to generate a pressure difference between inside and outside of the vacuum bag 103. Due to this pressure difference, the composite material 101 is pressed against the molding tool 102 and formed into the shape of the molding tool 102. During this process, the heating gas is circulated by a fan 107 so that the composite material 101 can be heated uniformly. The composite material 101 is maintained at the predetermined temperature for a predetermined period of time until it is cured and the molding process is completed. Then, the composite material 101 is cooled. Cooling water is supplied from outside to cool the circulating gas through a cooler 108 and thereby cool the composite material 101.

However, since heat is transferred through the gas in both the heating process and the cooling process, these processes take a lot of time, which results in a decrease in productivity. This is a problem to be solved.

In order to solve this problem, an autoclave apparatus disclosed in Patent Literature 2 (Japanese Unexamined Patent Application Publication No. 2012-153133) below is used. This apparatus is described with reference to FIG. 5. In this apparatus, steam is used as a heating medium instead of circulating air. A composite material 111 is sealed together with a molding tool 112 in a vacuum bag 113, which is then placed in a cylindrical vessel 115 through a door 114. Then, high-temperature and high-pressure steam is supplied into the cylindrical vessel 115 through a steam supply pipe 116. The steam flows directly to the vacuum bag 113, condenses on the top surface of the vacuum bag 113 and the bottom surface of the molding tool 112, releases a large amount of heat of condensation to the composite material 111 and the molding tool 112, and thereby rapidly raises the temperature of the composite material 111 and the molding tool 112. Concurrently, due to a pressure difference between the steam and the interior of the vacuum bag 113, the composite material 111 is brought into close contact with the molding tool 112 and thus formed into the shape of the molding tool 112. When the steam condenses into water, its volume is reduced to about one hundredth or less. Therefore, fresh steam further flows into a region where the condensation occurs, and the composite material 111 and the molding tool 112 are heated to an almost uniform temperature. The composite material 111 is maintained at a predetermined temperature for a predetermined period of time until it is cured and the molding process is completed. Then, the composite material 111 is cooled. Cooling is performed by spraying externally supplied cooling water through a cooling water supply pipe 117 to directly cool the vacuum bag 113. Thereby, the time required for the heating process and the cooling process can be reduced significantly.

### CITATION LIST

### Patent Literature

[Patent Literature 1] Japanese Unexamined Patent Application Publication No. 2009-51074

[Patent Literature 2] Japanese Unexamined Patent Application Publication No. 2012-153133

### SUMMARY OF INVENTION

### Technical Problem

As described above, heating by steam allows rapid heating and is suitable for molded articles with complex shapes. However, in order to further improve this autoclave molding apparatus, it would be necessary to solve the following problems.

During the above-described cooling process, the pressure of the cooling water to be supplied into the cylindrical vessel 115 must be higher than that of the steam inside the cylindrical vessel 115. Therefore, when the pressure of the steam is high at the start of the cooling process, a large pumping system is needed. In addition, since only the sensible heat of the cooling water can be used to cool the steam in the cylindrical vessel 115, a large amount of cooling water is needed. As a result, in order to shorten the cooling time, not only a large pumping system is needed but also power consumption is increased.

Accordingly, the present invention has been made to solve the above-mentioned problems, and it is an object of the present invention to provide a cooling method for a steam heating type autoclave molding apparatus, including a cooling process that allows efficient cooling in a short time without increasing the size of a cooling system.

### Solution to Problem

In order to solve the above problems, the cooling method for the autoclave molding apparatus according to the present invention is configured as follows.

More specifically, the cooling method of the present invention is a cooling method for a steam heating type autoclave molding apparatus 10 for use in molding a composite material 12 composed of a fibrous base material and a matrix. The autoclave molding apparatus 10 includes: a cylindrical vessel 18 in which a vacuum bag 16 containing the composite material 12 and a molding tool 14 is to be placed; a steam supply unit 20 configured to supply steam at a predetermined temperature into the cylindrical vessel 18; a steam release unit 22 configured to release the steam used for molding the composite material 12 from the cylindrical vessel 18; and a cooling water supply unit 24 configured to supply cooling water for cooling the molded composite material 12. The cooling method includes: releasing the steam through the steam release unit 22 to cool the molded composite material 12; and then spraying the cooling water supplied from the cooling water supply unit 24 to cool the molded composite material 12.

According to the cooling method for the autoclave molding apparatus of the present invention, when the pressure of the steam in the cylindrical vessel 18 is high at the start of the cooling process, the steam release unit 22 is used to reduce the pressure of the steam therein, and the equilibrium temperature of the steam corresponding to the reduced pressure thereof is used to cool the composite material 12. Then, after the pressure in the cylindrical vessel 18 decreases, cooling with the cooling water is started. This cooling method makes it possible to perform cooling with less power consumption and in a shorter time without increasing the size of the cooling system including the cooling water supply unit 24, such as a cooling water pump.

In the present invention, it is preferable that the steam release unit 22 includes a pressure reducing valve 26 for regulating an amount of the steam to be released and the pressure reducing valve 26 is controlled depending on a pressure inside the cylindrical vessel 18. It is also preferable that the cooling water supply unit 24 includes a flow rate regulating valve 28 or a cooling water pump for regulating an amount of the cooling water to be supplied and an opening of the flow rate regulating valve 28 or power of the cooling water pump is controlled depending on a temperature inside the cylindrical vessel 18 or a temperature of the composite material 12. It is further preferable that the cooling water supply unit 24 for supplying the cooling water includes a plurality of spraying means, from which the cooling water is sprayed to a plurality of surfaces of the vacuum bag 16.

Preferably, the present invention further includes particular components to be described in the following embodiments.

### Advantageous Effects of the Invention

According to the present invention, it is possible to provide a cooling method for a steam heating type autoclave molding apparatus, including a cooling process that allows efficient cooling in a short time without increasing the size of a cooling system.

### BRIEF DESCRIPTION OF DRAWINGS

FIG. 1 is a schematic diagram of an example of an autoclave molding apparatus according to the method of the present invention.

FIG. 2 is a diagram showing an example of a method of controlling the temperature and pressure in the heating and cooling processes according to the present invention.

FIG. 3 is a model diagram showing the temperature change and the cumulative amount of cooling water used in the cooling method of the present invention and those in a conventional cooling method.

FIG. 4 is a schematic diagram of a conventional autoclave molding apparatus.

FIG. 5 is a schematic diagram of a conventional steam heating type autoclave molding apparatus.

### DESCRIPTION OF EMBODIMENTS

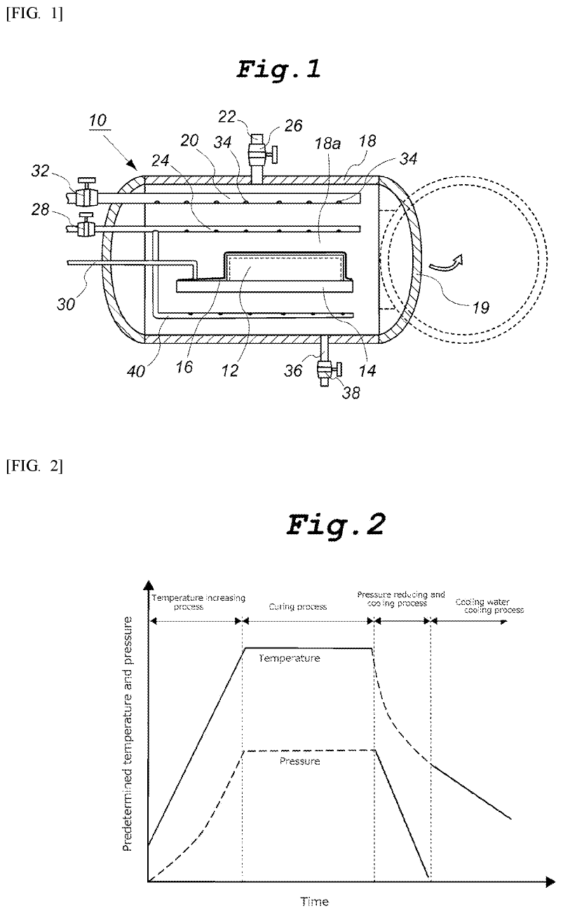

An embodiment of the present invention will be described with reference to drawings. FIG. 1 is a schematic diagram of an example of an autoclave molding apparatus 10 according to the method of the present invention. As shown in this figure, the autoclave molding apparatus 10 of the present embodiment is a steam heating type apparatus for use in molding a composite material 12 composed of a fibrous base material and a matrix, and mainly includes: a cylindrical vessel 18 in which a vacuum bag 16 containing the composite material 12 and a molding tool 14 is to be placed; a steam supply unit 20 configured to supply steam at a predetermined temperature into the cylindrical vessel 18; a steam release unit 22 configured to release the steam used for molding the composite material 12 from the cylindrical vessel 18; and a cooling water supply unit 24 configured to supply cooling water for cooling the molded composite material 12.

The composite material 12 made of a fibrous base material impregnated with a thermosetting resin matrix is sealed together with the molding tool 14 in the vacuum bag 16. The vacuum bag 16 is pre-evacuated and then placed in a molding chamber 18a of the cylindrical vessel 18 of the autoclave molding apparatus 10 through a door 19. Then, the vacuum bag 16 is connected to a vacuum unit 30 to maintain the vacuum during the molding.

Heat required for heating the composite material 12 is given by the heat of condensation of the steam supplied from the steam supply unit 20. The steam supply unit 20 includes a control valve 32 for controlling the temperature and equilibrium pressure of the steam to be supplied. The steam supply unit 20 further includes a plurality of steam nozzles 34 for supplying the steam uniformly. In the embodiment of FIG. 1, the steam supply unit 20 with the steam nozzles 34 is a single pipe, but may be divided into an appropriate number of branch pipes depending on, for example, the size of the molding chamber 18a. The steam flows directly to the vacuum bag 16 and condenses on the top surface of the vacuum bag 16 and the bottom surface of the molding tool 14. The steam thus releases a large amount of condensation heat to the composite material 12 and the molding tool 14, and thereby rapidly raises the temperature of the composite material 12 by heat transfer. When the steam condenses into water, its volume is reduced to about one hundredth or less. Therefore, fresh steam further flows into a region where the condensation occurs, and the temperature of the composite material 12 and the temperature of the molding tool 14 are both raised almost uniformly.

The condensed water thus produced during the heating is collected at the bottom of the molding chamber 18a and discharged from the molding chamber 18a by a drain water discharge unit 36. The drain water discharge unit 36 includes a drain water discharge valve 38, and the amount of water to be discharged is controlled depending on the amount of the collected drain water.

In order to cool a molded article of the composite material 12 (hereinafter also referred to simply as a “composite material 12 molded article”) in the cylindrical vessel 18 (more specifically, in the molding chamber 18a), the steam release unit 22 and the cooling water supply unit 24 are provided. In the present invention, the cooling process is performed in two steps: in the first step, the steam release unit 22 is used to reduce the pressure and thereby cool the molded article; and in the second step, the cooling water supply unit 24 is used to cool the molded article with cooling water.

In the first cooling step, the steam in the molding chamber 18a is released through the steam release unit 22 to reduce the pressure of the steam therein and thereby reduce the equilibrium temperature thereof. Thus, the composite material 12 molded article in the molding chamber 18a is cooled. The pressure reducing valve 26 provided in the steam release unit 22 is used to regulate the temperature decreasing rate. Even if the steam is released to the atmosphere, its temperature can only be reduced up to 100° C., which is the equilibrium temperature of the steam at atmospheric pressure. In the second cooling step, the cooling water supplied from the cooling water supply unit 24 is sprayed into the molding chamber 18a. The cooling water supply unit 24 includes a flow rate regulating valve 28 for controlling (regulating) the amount of the cooling water to be supplied.

As the composite material 12, a stack of layers of carbon fiber, aramid fiber, glass fiber, or the like is used. As the thermosetting resin matrix, epoxy resin, phenol resin, or the like is used. The vacuum bag 16 may be made of any material having heat resistance and water resistance, such as nylon and silicone rubber.

Next, how to control the temperature and pressure in each process of autoclave molding using the autoclave molding apparatus 10 according to the present invention is described with reference to FIG. 2. In this figure, the temperature and pressure indicated by solid lines are those to be controlled.

In a temperature increasing process, the temperature inside the molding chamber 18a is increased to a predetermined temperature while the amount of steam to be supplied is regulated. In this process, the pressure of the steam is the equilibrium pressure corresponding to the temperature thereof. The composite material 12 is pressed against the molding tool 14 due to the pressure difference between the equilibrium pressure and the pressure in the vacuum bag 16, comes into close contact with the molding tool 14, and then starts to cure. The time required for the curing process depends on the composition of the composite material 12 (in particular, for example, the type and amount of the matrix). The temperature of the steam is maintained at the predetermined temperature and the curing proceeds under the equilibrium pressure at that temperature.

After the curing process is completed, the cooling process is started to take the composite material 12 molded article out. The supply of the steam from the steam supply unit 20 is stopped, and then in the first pressure reducing and cooling process, the steam is released through the steam release unit 22. Since the temperature in the molding chamber 18a is the equilibrium temperature corresponding to the pressure therein, the temperature decreases as the pressure decreases. As the temperature of the steam decreases, the temperature of the composite material 12 also decreases. As the pressure decreases in this cooling process, the pressure difference between the pressure in the molding chamber 18a and that in the vacuum bag 13 also decreases. If the composite material 12 molded article may be deformed due to a temperature change after curing, the opening of the pressure reducing valve 26 can be changed to regulate the rate of reducing the pressure. Since the pressure reducing and cooling process can be performed only by the operation of the pressure reducing valve 26, the power consumption can be minimized. In addition, since the temperature in the molding chamber 18a is the equilibrium temperature corresponding to the pressure therein, the temperature in the molding chamber 18a decreases almost uniformly.

The following second step of the cooling process is a cooling water cooling process. When the pressure inside the molding chamber 18a decreases to approximately atmospheric pressure, the flow rate regulating valve 28 is opened to release the cooling water from the cooling water supply unit 24 and thereby cool the composite material 12 molded article in the vacuum bag 16. In this case, the pressure reducing valve 26 is closed when the pressure inside the molding chamber 18a decreases to a predetermined pressure. The drain water discharge valve 38 is opened, if necessary, to discharge the cooling water collected at the bottom of the molding chamber 18a. Since the pressure inside the molding chamber 18a is approximately atmospheric pressure, an increase in the pressure of the cooling water is minimized and thus the size of the pumping system and the power consumption can be reduced.

The power of the cooling water pump of the cooling water supply unit 24 may be controlled using an inverter or the like (not shown) so that the flow rate of the cooling water pump can be changed and thereby the amount of the cooling water to be supplied from the cooling water pump can be reduced when the temperature of the composite material 12 molded article drops. In this case, the power consumption can be further reduced.

In the above-described cooling water cooling process, the cooling rate is controlled based on the temperature of the composite material 12 molded article. The reason is as follows. Since the equilibrium pressure of the steam is equal to or lower than the atmospheric pressure when the temperature of the steam is 100° C. or lower, air is introduced into the molding chamber 18a (not shown), depending on the situation. However, if air is introduced into the molding chamber 18a, it is difficult to control the cooling rate based on the pressure. In addition, even if the cooling rate is controlled based on the temperature of the composite material 12 molded article, the temperature of the composite material 12 molded article varies from place to place depending on how the cooling water is sprayed, and therefore the cooling rate is controlled based on the reference temperature of the composite material 12 molded article.

Since the thermal conductivity of the composite material 12 is lower than that of metals, the composite material 12 molded article has a larger temperature difference in its thickness direction. Therefore, for example, the embodiment of FIG. 1 has a structure in which the pipe of the cooling water supply unit 24 is divided into a plurality of spraying means, like branch pipes 40, so as to cool both the top and bottom surfaces of the composite material 12. This structure allows the cooling rate to increase further.

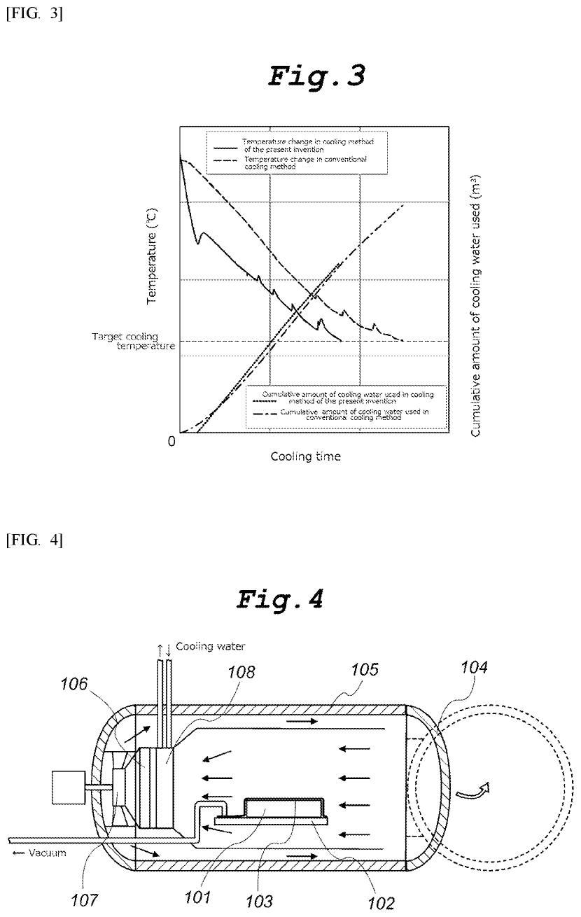

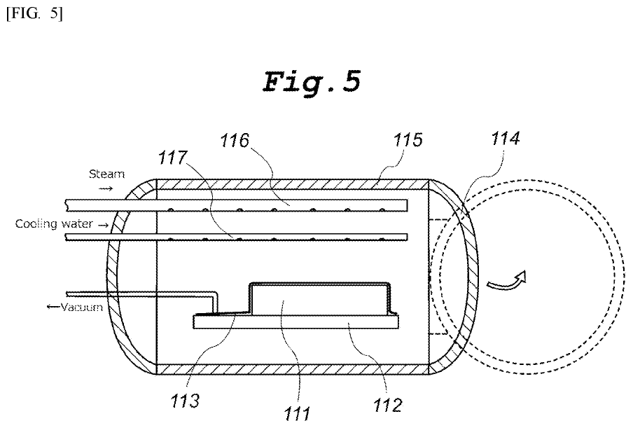

FIG. 3 is a model diagram showing the temperature change and the cumulative amount of cooling water used in the cooling method of the present invention and those in a conventional cooling method. This figure compares the two-step cooling method according to the present invention and the conventional cooling method using cooling water, and shows the relationship between the cooling time and the temperature change of the composite material 12 molded article and between the cooling time and the cumulative amount of cooling water required for cooling in each of the cooling methods.

In the two-step cooling method according to the present invention, cooling is performed by reducing the pressure to reduce the temperature to a predetermined value, and then cooling is further performed using cooling water. As shown in FIG. 3, it is proved that the cooling method of the present invention can reduce both of the cooling time and the amount of cooling water by about 30%, compared with the conventional cooling method.

As described above, according to the cooling method for the autoclave molding apparatus of the present embodiment, the first cooling is performed by releasing the steam to reduce the pressure, and then after the pressure is reduced, the second cooling is started using the cooling water. Therefore, it is possible not only to reduce the amount of cooling water consumed but also to reduce the time required for cooling, without increasing the size of the pumping system.

The above-described embodiment is an example where the opening of the flow rate regulating valve 28 and the flow rate (power) of the cooling water pump are controlled based on the temperature of the composite material 12 molded article. However, the opening of the flow rate regulating valve 28 and the flow rate (power) of the cooling water pump may be controlled based on the temperature of the molding chamber 18a (inside the cylindrical vessel 18), depending on the shape of the composite material 12 molded article, or the like.

### LIST OF REFERENCE SIGNS

10: Autoclave molding apparatus
12: Composite material
14: Molding tool
16: Vacuum bag
18: Cylindrical vessel
20: Steam supply unit
22: Steam release unit
24: Cooling water supply unit
26: Pressure reducing valve
28: Flow rate regulating valve

1. A cooling method for a steam heating type autoclave molding apparatus for use in molding a composite material composed of a fibrous base material and a matrix, the autoclave molding apparatus including: a cylindrical vessel in which a vacuum bag containing the composite material and a molding tool is to be placed; a steam supply unit configured to supply steam at a predetermined temperature into the cylindrical vessel; a steam release unit configured to release the steam used for molding the composite material from the cylindrical vessel; and a cooling water supply unit configured to supply cooling water for cooling the molded composite material, the cooling method comprising:
a first step of releasing the steam through the steam release unit to reduce a pressure inside the cylindrical vessel to approximately atmospheric pressure and thereby cool the molded composite material; and
a second step of spraying the cooling water supplied from the cooling water supply unit to cool the molded composite material.

2. The cooling method for the autoclave molding apparatus according to claim 1, wherein the steam release unit includes a pressure reducing valve for regulating an amount of the steam to be released, and the pressure reducing valve is controlled depending on a pressure inside the cylindrical vessel.

3. The cooling method for the autoclave molding apparatus according to claim 1, wherein the cooling water supply unit includes a flow rate regulating valve for regulating an amount of the cooling water to be supplied, and an opening of the flow rate regulating valve is controlled depending on a temperature inside the cylindrical vessel or a temperature of the composite material.

4. The cooling method for the autoclave molding apparatus according to claim 1, wherein the cooling water supply unit includes a cooling water pump that can change an amount of the cooling water to be supplied, and power of the cooling water pump is controlled depending on a temperature inside the cylindrical vessel or a temperature of the composite material.

5. The cooling method for the autoclave molding apparatus according to claim 1, wherein the cooling water supply unit for supplying the cooling water includes a plurality of spraying means, from which the cooling water is sprayed to a plurality of surfaces of the vacuum bag.
